(19) United States
(12) Patent Application Publication
(10) Pub. No.: US 2021/0102410 A1
(43) Pub. Date: Apr. 8, 2021

(54) Portable No-Lock Security Tether-Anchor Assemblage for Laptop Computers and Other Personal Property

(71) Applicant: Charles A. Smiley, III, Oakland, CA (US)

(72) Inventor: Charles A. Smiley, III, Oakland, CA (US)

(21) Appl. No.: 17/061,581

(22) Filed: Oct. 2, 2020

Related U.S. Application Data
(60) Provisional application No. 62/909,368, filed on Oct. 2, 2019.

(51) Int. Cl. E05B 73/00

(52) U.S. Cl. CPC E05B 73/0082; E05B 73/0005

(57) ABSTRACT

A nonlocking tether-anchor assemblage to protect laptop computers and similar devices from theft while used in. public, one embodiment comprised of an elongated means that horizontally extends the width of a computer laptop, said means having a cut in in the interior space of the means to create an opening that allows the means to be placed over a laptop computer display assembly and slid down to a resting position at the base of the assembly, firmly surrounding and holding the laptop computer inside of the opening. This elongated means connects to a tether that is wrapped around a relatively immovable object and attached using a nonlocking fastener at the end of the tether to secure the laptop computer to a localized area defined by the length of the tether. A second embodiment combines the elongated means and the tether into one piece of material that accomplishes the function of each as explained in the first embodiment. A third embodiment employs an attachment to the laptop computer that wraps around the base of the laptop computer display assembly like a belt. A fourth embodiment combines the belt and tether into one piece and allows an adjustment mechanism to manipulate a secure fit around the display assembly base.

### CROSS-REFERENCE TO RELATED APPLICATIONS:

This application claims the benefit of provisional patent application No. 62/909,368, filed on Oct. 2, 2019, by the present inventor, the disclosure of which is incorporated herein in its entirety.

### FEDERALLY SPONSORED RESEARCH

No.

### BACKGROUND

### Prior Art

The following is a tabulation of some prior art that presently appears relevant:

U.S. Patents

| Pat. No. | Date | Patentee | Kind Code |
|---|---|---|---|
| 3,785,183 | 1974 | P. Sander | |
| 5,632,165 | 1997 | R. Perry | |
| 5,692,400 | December 1997 | Bliven et al. | |
| 5,913,907 | 1999 | M. Lee | A |
| 6,360,405 | 2002 | McDaid, et al. | B1 |
| 8,368,536 | 2005 | Fawcett, et al. | B2 |
| 6,883,694 | 2005 | B. Abelow | B2 |
| 9,103,142 | August 2015 | Abdollahzadeh et al. | B2 |
| 0,147,041 | June 2010 | M. Teicher, et al. | A1 |
| 5,836,183 | November 1998 | J. Derman | A |
| 0,028,571 | February 2005 | Merrem, et al. | A1 |

Foreign Patent Documents

| | | |
|---|---|---|
| EP2721232B1 | August 2017 | Myers, et al. |

### NONPATENT LITERATURE DOCUMENTS

Grand Canyon University. A Lost Laptop Is a Cybersecurity Threat. First published Nov. 1, 2019, available at https://www.gcu.edu/blog/engineering-technology/lost-laptop-cybersecurity-threat as of Sep. 26, 2020.

Ponemon Institute LLC. The Billion Dollar Lost Laptop Problem (Benchmark study of U.S. organizations sponsored by Intel). First published Sep. 30, 2010 and available at https://venturebeat.com/wp-content/uploads/2010/12/the_billion_dollar_lost_laptop_study.pdf as of Sep. 26, 2020.

Sharp, Nathan. 7 Shocking Statistics That Prove Just How Important Laptop Security Is. Sep. 10, 2018.) https://securityboulevard.com/2018/09/7-shocking-statistics-that-prove-ust-how-important-laptop-security-is/

Kensington Device Security Keyed Locks, locking stations, and noninvasive solution for laptops without a security slot, like Apple's MacBooks. https://www.kensington.com/c/products/technology-device-securitv-products/device-security-keyed-locks/?srt=relevance&rslt=34, https://www.kensington.com/c/products/technology-device-security-products/locking-stations-for-laptops/?srt=relevance, and https://store.kensington.com/products/kensington-macbook-lock-combo-cable-lock-and-locking-station-for-11-15-6-macbooks-chromebooks-and-thin-laptops-k64454ww?variant=32399377236017&gclid=CjwKCAjw8MD7BRArEiwAGZsrBTepshi9ctvZ CGeqo3jHAPwCFg3DgDzN7GDsJpNloaM6dwu415FbzxoC7D8QAvD_BwE as of Sep. 27, 2020.

Targus Cable Locks catalogue. https://us.targus.com/collections/cable-locks as of Sep. 27, 2020.

### FIELD OF THE INVENTION

The present invention relates generally to the security of laptop computers and similar devices to deter and prevent theft. More particularly, the invention uses a tether-anchor assemblage without any locking mechanisms to protect these devices against snatching thefts while the device is being used in public. In an exemplary embodiment, an elongated means containing a slit cut into the interior of the means allows the means to slide over and down the laptop computer display assembly to a resting place at the base of the display assembly below the monitor. The slit allows the means to firmly surround the laptop computer in this position. The elongated means connects to, or is part of, a tether. While one end of the tether connects to the elongated means, the other end attaches to a nearby relatively immovable object. This anchoring is accomplished by wrapping the tether around the object and using a connector at the end of the tether to connect to another point in the tether. The length of the tether creates a limited range of movement.

### BACKGROUND OF THE INVENTION

“Snatch-and-run thefts” are crimes of opportunity that occur when a person quickly grabs another person's property without permission and runs off with the intent to steal the property. These crimes target laptop computers users with rising frequency due to the increasing widespread use of these valuable devices in public. With 5G technology on the horizon, mobile access to data will increase. Already, wireless technology allows electronic devices to be used in a variety of public settings. Coffee shops, libraries, campuses, restaurants, parks, museums, public transportation carriers, airports, hotels, and malls are some of the most popular public places for laptop computers to be used and stolen. The theft of such electronic devices often has far-reaching consequences as more and more of people's lives, work product, and sensitive corporate or personal data is stored inside. One research company has determined that “a laptop is stolen every 53 seconds.” (Grand Canyon University. A Lost Laptop Ls a Cybersecurity Threat.) “[T]raveling laptops seem to be most vulnerable to theft.” (Ponemon Institute LLC. The Billion Dollar Lost Laptop Problem.) “Figures have shown that theft often occurs in offices, public transport, airports, restaurants and hotels.” (Sharp; Nathan. 7 Shocking Statistics That Prove Just How Important Laptop Security Is. Sep. 10, 2018.) For corporations, the loss of a single laptop, on average, costs the company $49,246 when the value of lost data is factored into the analysis. (Ponemon Institute LLC. The Billion Dollar Lost Laptop Problem, infra.)

Devices have been developed to inhibit the theft of laptop computers and similar equipment. Security systems in the prior art commonly rely on locking mechanisms as a principal component of their anti-theft features. These existing solutions involve keyed locks, coded locks, and combination locks. Many of these lock systems require a small slot to be built into the external wall of a laptop computer by the manufacturer into which a cable is locked and anchored by a tether to a nearby object. These slots come in different shapes and sizes depending upon the manufacturer and model. Some laptop computer brands do not have a security slot. Other locking solutions require modification of the laptop computer itself; adhesives are used to attach a base to a surface of the laptop computer to which a locking system is connected. Other iterations of locking devices involve locking stations, protective cases, or some combination of the above-described locking features to achieve their purported purpose.

These locking products deter theft. But products using locks are inadequate solutions for the snatching thefts that target electronic devices used by individuals in public. The locking of private property to the fixtures, tables and chairs of a business, public transportation carrier, or college campus, for example, requires the permission of the business owner, carrier, or school. Whether permission is granted depends on the duty of care owed to its licensees, risks associated with premises liability, and the business disruption that would result from lost keys and forgotten combinations. Public venues are likely to lack enthusiasm for the idea of permitting their property to be encumbered by customers locking their devices to the business. In this sense, the use of locking mechanisms is inconsistent with the public use of laptop computers.

The use of locking mechanisms in the prior art has significant application against burglaries at businesses and schools or when used in retail merchandise displays. In those instances, the lock protects the merchandise even when the owner is not in the immediate presence of the merchandise to discourage theft. While individuals are using their laptop computers in public, however, the user is in the presence of the property. This reduces the need and efficacy of a locking mechanism in tether systems. A nonlocking tether system equally interrupts the elements of speed and surprise in snatching crimes in public.

The existence of locks in a laptop security solution reduces convenience to the user. Because the lock is often made of metal, it is heavier. The need for a key or combination translates poorly to laptop computer users whose computer usage involves frequent movement.

The prior art has not kept up with the widespread use of laptop computers in public. This modern usage favors the absence of locking mechanisms in security tether assemblages. Without building locks into the solution, a tether-anchor assemblage can be produced more inexpensively, employ lighter, more portable materials, and have application across all laptop computers types regardless of size or brand. The combination of low cost and ease-of-use makes a nonlocking tether-anchor theft solution available to more laptop users than the current art permits.

One distinguishable prior art demonstrates the use of a tether-anchor system for laptop computers for a purpose that does not focus on theft prevention and would be ill-suited to that purpose if attempted. U.S. Pat. No. 6,883,694 by B. Abelow (2005) uses tethers to attach a laptop computer to the user's body for the function of balancing a notebook computer on one's lap. As depicted in the patent's embodiments, the methods of attaching the computer to the human body risks bodily injury to the user if worn to prevent opportunity crimes like snatch-and-run theft.

In summary, there is a gap in the prior art. There now exists a need for an effective laptop computer antitheft device that addresses the use of laptop computers in public; that addresses the crime of snatching thefts specifically; that does not employ the use of locks, keys, codes or combinations; that does not require a slot manufactured into the laptop computer, or an external base glued to a surface of the laptop computer; that does not require the computer to be housed in station; that is portable, lightweight and durable; that can be used on all types of laptop computers regardless of size or brand; that is inexpensive to produce; and that is simple to use by all ages of students and adults who use laptop computers in public.

### SUMMARY OF THE INVENTION

The present invention is an efficient, cost effective and easy to use nonlocking tether-anchor assemblage designed to deter and prevent opportunity crimes like the snatch-and-run theft of laptop computers and similar articles when such articles are used in public.

In accordance with one embodiment and using laptop computers as an exemplary illustration, the assemblage consists of an elongated means having a slit cut into the interior of the means. The slit is shorter than the full length of the means and sufficient to closely fit around a display assembly of a laptop computer. The user moves the elongated means over the top of the display assembly and slides the means down to the base of the display assembly, fitting the laptop computer display assembly into the slit of the means. In the resting position at the base of the display assembly, the means surrounds all sides of the display assembly to hold the laptop computer. For one-size-fits-all embodiments, the means wraps around the base of the monitor like a belt, with or without an adjustment mechanism to manually tighten or loosen the grip the means has around the base of the laptop computer's display assembly base.

The elongated means is attached to a tether portion of the assemblage that is anchored to a nearby immovable object. The end of the tether that is not attached to the elongated means has a nonlocking carabiner, spring snap or similar fastening device attached. This end of the tether is wrapped around a nearby immovable or heavy object and attached to a point in. the tether using the fastening device to form the anchor. Once attached in this fashion, the laptop computer is secured to a localized range of motion determined by the length of the tether.

The present invention achieves its antitheft goal without the use of locking mechanisms or docking stations, and in a way that is inexpensive to produce, that is lightweight, portable, easy for most ages to use, and that fits all laptops regardless of brand or size.

### Advantages

The present invention
Is a portable, non-locking device that deters and prevents the snatch-and-run theft of personal property, including but not limited to electronic devices such as laptop computers used in public The non-locking function is critical to allowing this device to be used in diverse public places like restaurants, cafes, campuses, businesses and public transportation;
Creates a visible deterrent to theft;
Allows for the use of a wide range of materials in its construction to achieve its aims of deterrence and theft prevention;
Is designed in a way that requires no modification or addition to the secured article;
Is designed to avoid interference with the intended use and function of the secured article;
Is organized in a way that efficiently disrupts snatch-and-run thefts by defeating the element of surprise and speed with conspicuous and actual barriers to completion of the crime;
Is lightweight, and comparatively lightweight when compared to solutions with metal locking mechanisms;
Is portable and easy to quickly apply to a laptop computer, making it especially useful for portable computer uses where the user must frequently relocate in using the laptop computer or electronic device in public;
Requires no keys or combinations and therefore creates no additional responsibility to maintain or replace keys or codes. The security device will not need to be destroyed if the key is lost or the lock is damaged.
Can be used with most laptops regardless of size or brand;
is inexpensive to produced compared to security tethers that involve locks;
Does not require the maintenance of keys or memorization of combinations or codes; and
Is easy for all ages of public computer users to operate.

### EMBODIMENTS

Some embodiments of this nonlocking tether-anchor assemblage include:
A preferred embodiment: An elongated means is positioned at the base of the laptop computer display assembly by sliding it down the assembly to the base of the laptop computer. The elongated means is attached to a tether by a connective device. At the other end of the tether lies the anchor, a carabiner-type device that allows the assembly to be secured to a relatively immoveable object (e.g. pole, table or chair) by encircling the object and fastening the carabiner-type device to a portion of the tether, forming the anchor part of the assemblage.
   The elongated means may be made out of a single piece or multiple pieces of rubber, silicon, plastics, fabric, webbing, leather, Velcro, wire, or similar materials, or combination of materials, and fashioned to fit snugly around the base of a computer laptop display assembly, reducing the ability of a thief to pull, cut or break the elongated means. The elongated means may be fabricated to a particular or may be comprised of materials that support the ability to adjust the elongated means to fit any laptop computer size as with materials that have elastic properties. The Attachment is attached to the tether and anchor using a connector. The elongated means may be treated with chemicals, coverings, and/or sleeves that increase the strength and resistance of the materials to cutting or breaking.
   The use of fabrics, webbing, tubing, rubber, silicon, leather, wire, covered braided steel, Velcro, and/or plastics, or any combination of these or similar materials may comprise the elongated means and tether. For the Attachment, tether, and anchor, the goal is to maximize strength while being gentle enough not to damage the secured property. The tether must be strong, resistant to cutting or breaking, flexible, and lightweight.
Second embodiment: Similar to the preferred embodiment above, except the elongated means and the tether are one piece and fashioned from the same material.
Third embodiment: the elongated means, as illustrated in FIG. 4, is comprised of material like webbing or leather or other strap-like material and rests at the base of the laptop computer's display assembly surrounding the base like a belt.
Fourth embodiment: Similar to the third embodiment, except the elongated means may be manipulated in size with the use of a buckle or other adjustment device to allow the user to control the size and tight fit of the elongated means against the base.

This invention is not restricted to the embodiments described herein. Variations may be made to the nonlocking tether-anchor assembly without departing from the scope of the invention.

To accomplish the above objects, this invention may be embodied in the forms illustrated in the drawings that follow. These drawings are illustrative only. Changes may be made in the specific construction illustrated and described within the scope of the claims.

### DRAWINGS

FIG. 1 is a perspective right side view of the separate components of a preferred embodiment of this tether-anchor assemblage showing the elongated means 1, tether 3, and anchor assembly 4 against a bistro table 6. As depicted, the elongated means is suspended above a laptop computer 5 and the tether 3 is not connected to the elongated means. The tether 3 connects to the leg of a bistro table by circling the table leg and connecting a snap, hook, carabiner, or other connector to a portion of the tether 3. This illustration demonstrates one way the invention might be used for its specific anti-theft purpose.

FIG. 2 is a perspective right side view of the same embodiment depicted in FIG. 1 except that the elongated means is now in its resting place at the base of the laptop computer display assembly and the tether 3 is connected to the elongated means 1. (The laptop computer is illustrated as suspended above the table to demonstrate the assembly).

FIG. 3 shows two views of the elongated member 1. It shows a top view and a side view as labeled in the figure. The top view illustrates a rectangle-shaped elongated means that has a slice removed from the interior section of the elongated means so that the slice does not extend to the edges and is surrounded on all sides by the elongated means. The removed slice of the elongated means is where the means will slip over the top of a laptop computer, be slide down the display assembly and monitor, down to the base of the display assembly. A hole on the side of the rectangle 1A allows a method of attaching the tether to the elongated means. The side view illustrates what the user would see when the elongated means is placed in accordance with the invention at the base of the laptop computer's display assembly.

FIG. 4 shows an embodiment of the tether-anchor assembly using fabric, webbing, or similar strap material to create an elongated means that fits tightly around the base of the laptop computer's display assembly. The elongated means attaches to the tether and the tether is attached to the table using the anchor assembly of a loop at the end of the tether 16 and a carabiner 15.

FIG. 5 shows one embodiment an anchor assembly consisting of a loop at the end loop 16 of a braided steel tether 11 and a carabiner 15 (or other connector) attached to the tether end loop 16. The carabiner 15 encircles an immovable object like a table leg and connects to another portion of the tether to complete the anchoring of the assemblage.

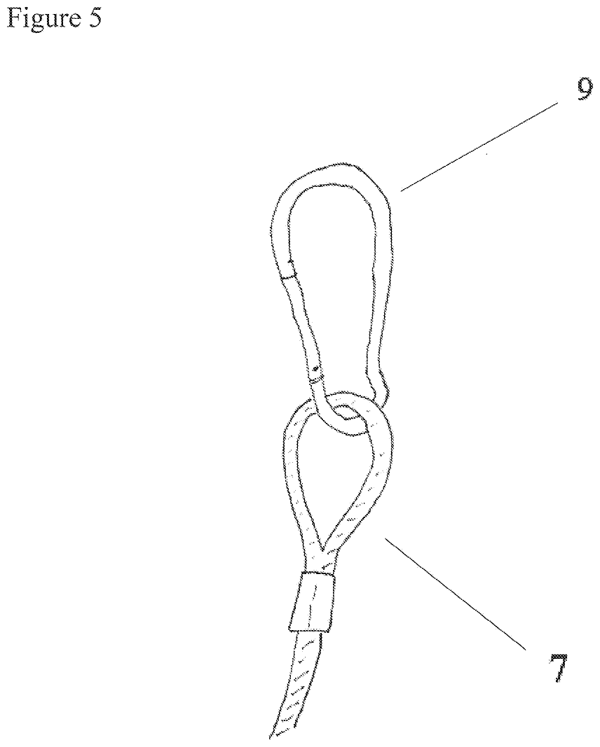

FIG. 6 is a closer view of FIG. 1

### DESCRIPTION

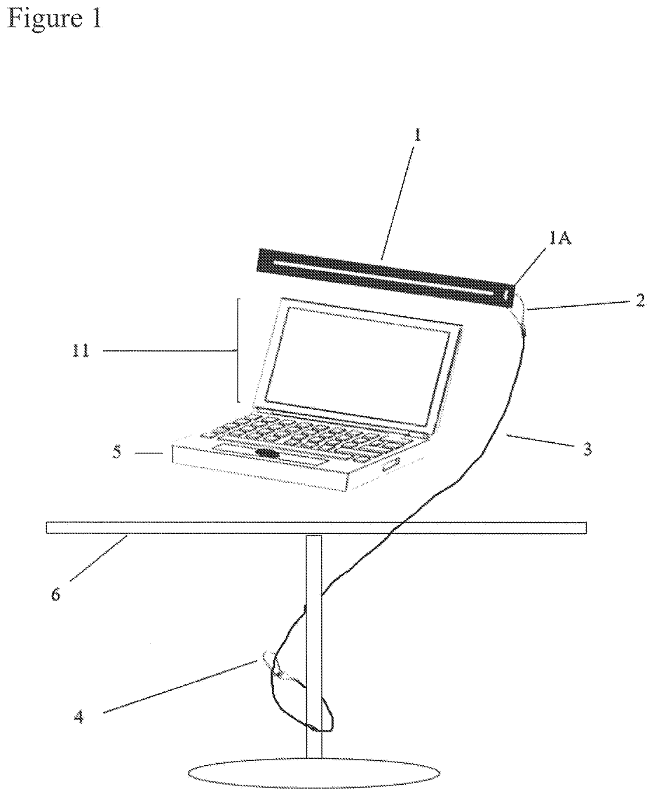

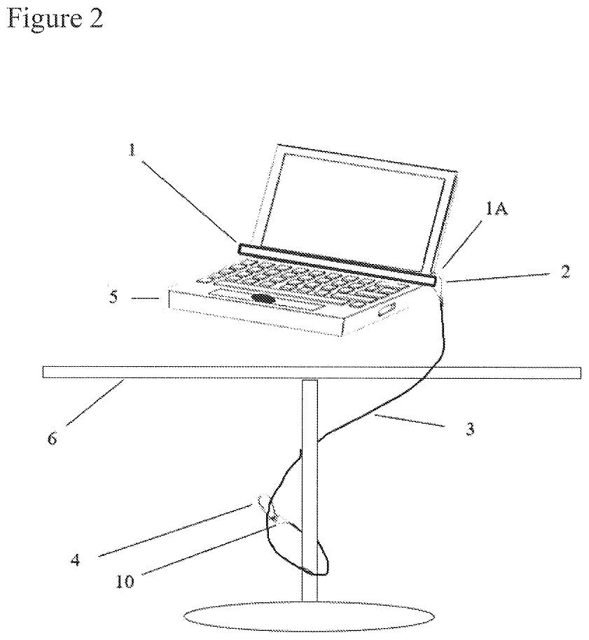

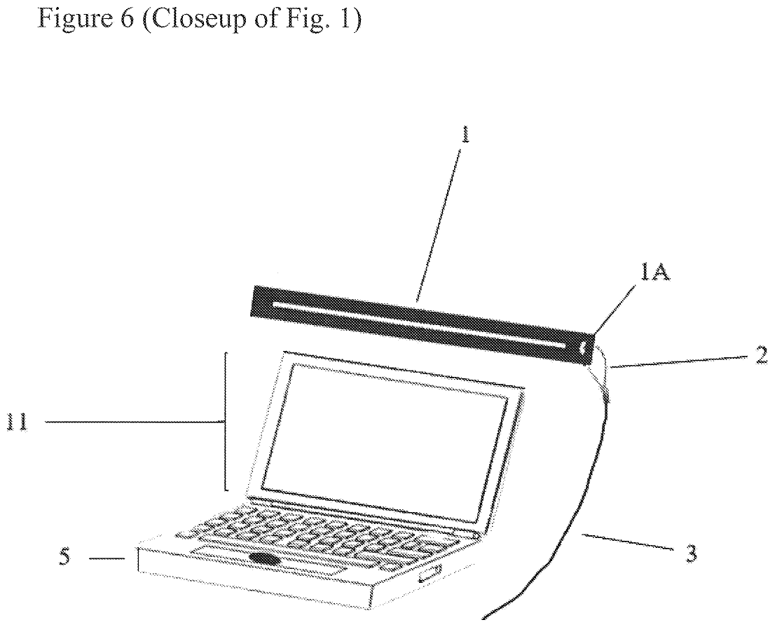

FIGS. 1, 2 and 6 show a general view of one embodiment of the tether-anchor assemblage. The laptop computer 5 is a clamshell design having two main components: a display assembly 11 and the keyboard component. The elongated means 1 contains a slit in the interior of the means. To use the assemblage, the elongated means 1 is placed over the laptop computer's display assembly 11. The user slides the elongated means down the display assembly to the base of the display assembly. The elongated means surrounds all sides of the elongated means. The slit of the elongated means is of sufficient narrowness to firmly bold the laptop computer. This also defeats the quickness required to steal items in snatching thefts.

The elongated means has a hole 1A at one or both ends. As depicted in FIGS. 1, 2, and 6 the hole 1A is on the right side of the elongated means. This hole connects to the tether 3. A connector 2 fits into the hole 1A to attach the tether to the elongated means. The connector may be a mechanism that cannot be removed from the hole; it may also be a removable mechanism, allowing users to change tether length, color, and design to personalize and make the assemblage more conspicuous as a deterrent.

The connection of the tether 3 to the hole 1A of the elongated means 1 secures the laptop computer. Next, the elongated means and the tether must be affixed to a nearby relatively immovable object. At the end of the tether that is not attached to the elongated means is the anchor assembly 4. The anchor assembly is comprised of a loop at the end of the tether 10 which the user wraps around the nearby relatively immovable object like a table leg. Attached to the loop 10 is a carabiner 9 that attaches to a portion of the tether to secure the assemblage. This create a limited range of motion dictated by the length of the tether.

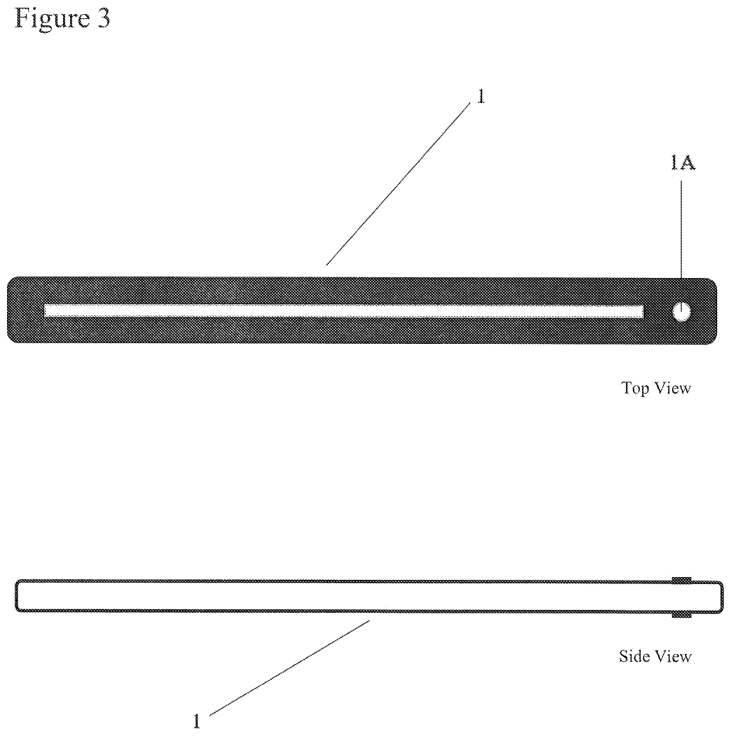

The elongated means and corresponding interior slit may be arranged in ways that optimize protection against slashing or cutting such as by positioning the slit to add more material on one side of the display assembly to increase protection against cutting or slashing. FIG. 3 shows a top- and side-views of the elongated means depicted in FIGS. 1, 2, and 6. The top view shows the slit in the elongated means into which the display assembly of a laptop computer is placed to attach the elongated means to the computer. The hole (1A) is pictured on the right side of the elongated means. This hold attaches to the tether in the embodiment of FIGS. 1, 2 and 6.

Another embodiment would not require a hold, but instead comprise the elongated means and tether of one piece of material that needs no connectors.

The side view of the elongated means is a view of what the user would see of the elongated means when the elongated means is in its resting position at the base of a display ready for use.

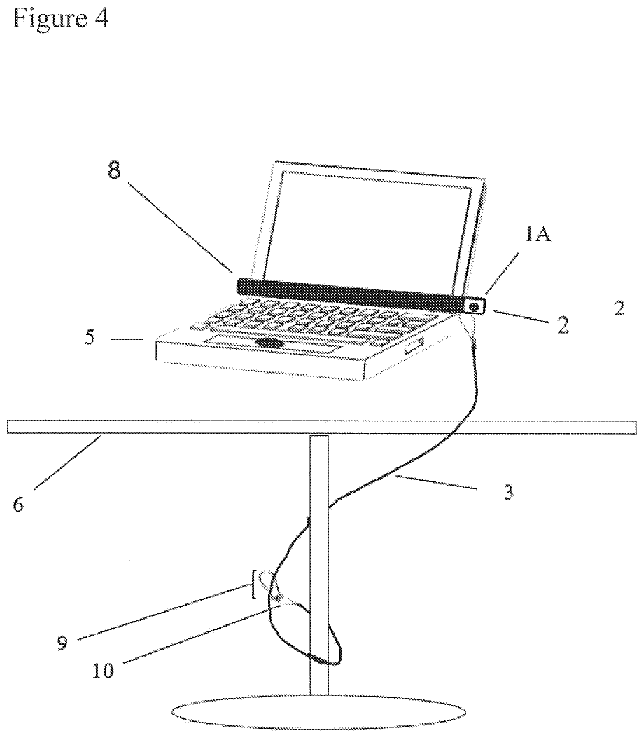

FIG. 4 shows another embodiment of the elongated means. Here, the elongated means 8 is constructed of a strap-like material like webbing to create a belt around the base of the display assembly of the laptop computer. This version of the elongated means has a hole 2 for use an attachment to the tether 3.

Another embodiment of this strap assemblage needs no hole where the elongated means and the tether are comprised of the same piece of material. Further, this strap elongated means allows for the assemblage to be a one-size-fits-all solution where the addition of Velcro or buckles would allow the user to control the length and firmness of the elongate means' grasp of the laptop computer.

In the use of both embodiments included here for illustration, the tether and anchor may be positioned to run next to the laptop computer user's body providing no more inconvenience that a power cord for the computer.

Preferred constructions of the embodiments to this invention will use matexials that resist cutting and have tensile strength. These designs do not interfere with the normal use of laptop computers including those with touch-screen capabilities.

The embodiments identified have been selected to best explain the principles of the assemblage and its practical application, to enable others skilled in the art to understand and utilize the assemblage and its various embodiments including suitable modifications.

Definitions: As stated above, use of the term “laptop computer,” broadly includes all portable computers program or electronic screen-viewing products, apparatuses and systems, however named, such as, but not limited to, computer notebooks, tablets, 2-in-1 hybrid tablet/laptop devices, electronic gaining devices, multiple screen devices, portable streaming device or portable televisions, and other instruments or devices that resemble in whole or part the traditional clamshell laptop computer design (having a folding display assembly and attached keyboard assembly) or that resemble said laptop computer design by physical characteristics or operation. These definitions are not intended to limit the range of items applicable to this art's application. These terms are used to aid illustration of the tether-anchor assemblage's general uses and background. References to laptops computer herein should not be read to apply exclusively to laptop computers, but to all the above described items whether currently known or yet to be invented.

The term “elongated means” as used herein refers to the portion of the assemblage contacts and holds the laptop computer at the base of the computer's display assembly. This portion of the assemblage surrounds the base of the display assembly on all sides. The elongated means may be fashioned out of various materials to accomplish the aims of deterrence and theft prevention, attractive design, compatibility with specific products, and portability. These materials may include materials such as wires, ropes, cables, rubber or silicon, fabrics, webbing, tubes, elastic materials, graphene and other strengthening ingredients, and similar materials or any combination of such materials and ingredients. A significant feature of the elongated means is that it hugs the monitor firmly ideally create some gentle resistance in embodiments where the elongated means slides down the display assembly into position at the base.

The term “band” or “cable” in reference to the tethering device that attaches to personal property includes materials such as wires, cables, rubber or silicon bands, fabrics, webbing, tubes, ropes, strengthening coating agents, and other materials, or combinations of materials, that possess similar functions to these materials.

The term “connector” refers to a device, including a hole or loop, used to connect the elongated means to the tether or the tether to a carabiner or similar device that comprises the anchor assembly. “Connector” encompasses devices including brackets, buckles, adjusters, hooks, carabiners, Velcro, and other materials of similar look, feel, or function.

The term “buckle” includes all variation of buckles (e.g. side release buckles, cam buckles, lock buckles, etc.) of whatever material including plastics and rubber.

The term snatching theft or snatch-and-grab theft is identical in meaning to the term grab-and-run theft. As used in this application, the terms include all similar crimes of opportunity where speed and surprise are used by the wrongdoer to steal property in the general presence of the user and carry it away without the user's permission.

The “display assembly” is the portion of the laptop computer that contains the screen or monitor on its inner side, and a protective covering on its outer side. The display assembly also often contains cameras and microphones on many models.

The term “lock” refers to a mechanism for keeping an article fastened and operated only by a key of a particular form, or certain code or combination, or another unique feature.

### REFERENCE NUMERALS

1 Elongated means
2 1A Hole in the elongated means
3 connector
4 tether
5 anchor assembly
6 laptop computer
7 table
8 braided steel cable
9 Strap embodiment of the elongated means
10 Hook
11 Loop at the end of the tether
12 “Display Assembly” portion of a laptop computer

What is claimed is:

1. A portable security device without locking mechanisms for protecting laptop computers and similar articles from theft occurring in presence of the user while the article is used in public, the device comprising
a. An elongated means that horizontally extends the length of the laptop computer display assembly and contains a slit in the middle of the elongated means that allows the slit of the elongated means to fit firmly around a laptop computer's display assembly and allows the elongated means to slide down the assembly to a resting place at the base of the display assembly to hold the laptop computer, and
b. A separate tether connecting to the elongated means that fastens to a relatively immovable object by use of a connector at the end of the tether that is wrapped around the immovable object and attached to a point in the tether to secure the assemblage to the immovable object.

2. A method for securing laptop computers and similar articles from snatching thefts when the articles are used in public in accordance with claim 1.

3. An assemblage in accordance with claim 1 where the elongated means and the tether are one piece and no connector to connect the two is needed.

4. An assemblage in accordance with claim 1 but where the elongated means is comprised of a strap that firmly surrounds the base of the display assembly of a laptop computer and connects to a separate tether that attaches to an immovable object in accordance with claim 1b.

5. An assemblage in accordance with claim 4 but where the elongated means and the tether are one piece and no connector to connect the two is needed.

6. An assemblage in accordance with claim 4 but where the elongated means can be manipulated to control the size and tightness of the elongated means around the base of the laptop computer display assembly.

7. A method for securing laptop computers and similar articles from snatching thefts when the articles are used in public in accordance with claims 4, 5, and 6.
